(19) United States
(12) Patent Application Publication
(10) Pub. No.: US 2012/0210119 A1
(43) Pub. Date: Aug. 16, 2012

(54) Method and Apparatus for Secure Internet Browsing

(76) Inventors: Arthur Baxter, Chicago, IL (US); Linda Spulak, Indian Creek, IL (US)

(21) Appl. No.: 13/293,024

(22) Filed: Nov. 9, 2011

Related U.S. Application Data
(63) Continuation-in-part of application No. 11/151,882, filed on Jun. 13, 2005, now abandoned.
(60) Provisional application No. 60/579,356, filed on Jun. 14, 2004.

(51) Int. Cl. H04L 9/28; G06F 15/16

(52) U.S. Cl. 713/150

(57) ABSTRACT

A method and apparatus for providing users with permission-based secure Internet browsing of sponsored and unsponsored content by connecting a portable storage/secure connection device to a host computer, activating firmware in the device causing the host computer to recognize the device as peripheral hardware, and assuming control of the host computer's Internet browser registry key to re-direct Internet click stream data onto the device or a data server instead of the host computer. Information is encrypted and transmitted via a secure protocol to a proxy server then redirected to a web server that authenticates the device via software on the device, an application server facilitating user authentication via security questions, requests and captures specific information from the user to create a profile, initiates corresponding scripts, applications, encryption and stores user-defined personal information for secure and user-authorized user data transmission and Internet browsing activities based on user-defined consent and access criteria.

This application is a continuation-in-part of U.S. patent application Ser. No. 11/151,882, which claims the benefit of the filing date of provisional application No. 60/579,356, filed on Jun. 14, 2004.

### BACKGROUND

Corresponding with an increased prevalence of electronic, network-based transactions, a need exists for protecting personally identifiable information (PII) and for providing both secure and convenient transactions. As computer users increasingly provide PII over the Internet, businesses increasingly engage in harvesting personal data for marketing and other purposes. For this reason, a lack of trust and disincentive exists making consumers reluctant to provide PII online.

Therefore there is a need for a method enabling users to establish trust-based relationships with known companies and securely provide PII free of data gathering by third parties. There is also a need for a tool that facilitates single sign-on methodologies while providing a secure and private connection to the Internet, allowing users to avoid third party tracking of their browsing activities. From a business perspective, there is also a need to provide sponsors with a secure and private pathway to distribute user-specific information, transparently capture PII, and provide the information to third parties identified by the user.

### SUMMARY

The present invention comprises a portable storage/secure connection device which may be used in conjunction with a computer running a WINDOWS™ or similar operating system. When the portable storage/secure connection device is inserted into a USB or similar connection to a computer, a user is prompted to register the device. Once registered, it operates automatically upon connection to a computer to change the operating system registry, directing information generated during web browsing to the device memory rather than the computer's hard drive. When the device is removed from the computer, the registry settings revert to a previous setting.

The information stored on the portable storage/secure connection device may be maintained thereon and employed when next connected to a computer. The portable storage/secure connection device is used in one embodiment to facilitate capture of demographic information for targeted marketing purposes using a user authentication, privacy and consent system associated with the device. For ease of reference, that authentication system will be referred to herein as the “Passport System.” Using the Passport System plus a user-generated password and a unique device identifier (UDI), the portable storage/secure connection device verifies the user's identity and works in conjunction with Internet resources to provide user-authorized targeted marketing and selected advertisements to the user based on evolving personal privacy and consent preferences set by the user, and an evolving Internet click stream history profile.

Upon authentication, a Passport System application tracks the user's portable storage/secure connection device interactions with a sponsor of the portable storage/secure connection device, with four primary panels in a personalized user interface secure web portal: First, a sponsor panel comprises the main window of the user interface. Within this interface, the sponsor may present a message to the validated user of the portable storage/secure connection device. Second, a service menu provides additional informational links for the user, populated either by the sponsor, or a distributor of the portable storage/secure connection device for additional marketing opportunities such as up-selling and cross-selling. Third, a protected browsing tab opens a secondary browser window in which a user may access the Internet via a proxy server, which serves as a secure gateway as well as receptacle for browsing devices (cookies, etc.) used to track users, leaving no trace of surfing activities or pages visited on the host computer. Finally, the Passport System application and data servers, which maintain an active dialog between the end user and sponsored web pages, captures the user's click stream history of interactions on the sponsor's site on the proxy server.

Content delivered to the sponsor panel is administered via a web-based utility allowing a variety of media content, whether static, dynamic or interactive to be delivered on a schedule. It also permits the creation of links for the service menu, the uploading of new images for the toolbar, and the downloading of reporting data for analysis by the sponsor for marketing purposes.

A unique device identifier (UDI) is used when the portable storage/secure connection device connects to the Passport System via the user's host system. UDI data elements embedded within the portable storage/secure connection device are utilized when combined with system generated elements to create each UDI, and firmware is accessed during the initial registration of the portable storage/secure connection device with the Passport System to authenticate the device and grant access to the user communication interface. The UDI also creates an association between the user communication interface database and the end user's authorized browsing activities at the sponsor site, allowing a variety of activities such as marketing intelligence, regulatory compliance or site administration.

Along with the UDI code, the portable storage/secure connection device and Passport System protect against fraud over the Internet through a two-factor authentication system. Other security features include implementation of SSL protocols and proxy server(s) that cloak the user's identity and browsing activity.

In one embodiment of the invention, the portable storage/secure connection device is equipped with a radio frequency transceiver, designed to sense other transceivers in commercial environments and display messages on the device.

The portable storage/secure connection device also contemplates a marketing method in which the portable storage/secure connection device is sold as a packaged, turnkey solution to the sponsor. This package includes the distribution of a large number of portable storage/secure connection devices with installed UDIs and proprietary software. One alternative embodiment of this method allows downloading the UDI and software from the portable storage/secure connection device to the sponsor's server.

The packaged solution also includes access to a basic Passport System site. Since each portable storage/secure connection device can access the basic Passport System upon first use, it needs no preliminary updating or programming. An end user must personalize the device with a password when the device is first used and registered. That user must also determine what personal information to provide in order for the sponsor to ascertain what relevant information is allowed to be released to the user during the first authentication. By doing this, the user becomes an authorized system member, and the site begins performing user-authorized data mining operations for the sponsor.

User-provided personal information includes information governing, for instance, where and when a marketer may contact a user, referred to herein as “touch point” information. In order to gain member privileges in the Passport System, the portable storage/secure connection device user must opt-in to a privacy interface to document their preferred touch points. During the opt-in process, the user enters relevant personal information, defines the sponsor's use of information and touch points; what information to disseminate or restrict, and where to disseminate that information. The touch points and relevant personal information establish the user's market segmentation profile. When the user activates a touch point or privacy trigger, the Passport System back end uses that touch point trigger to determine what type of communications the user is seeking and when or how he wants to receive that communication. One or mote touch points may be used together to make these determinations, and sharing the information can add touch points to a user's database profile. Shopping and purchasing through the Passport System may also add touch points. Shopping behavior touch points automatically help the sponsor to build a user profile. The user initiates the process through purchases, or by activating a sponsored feature. For example, a user who takes advantage of a particular buyer reward indicates an interest. A book purchase might help the sponsor to sell a related DVD.

A sponsor of the portable storage/secure connection device may customize the device with a logo, packaging, and may even require a particular type of memory device that can be tailored to that sponsor's needs for product flexibility. Some of the hardware variations possible in alternate embodiments of the portable storage/secure connection device include removable drives for portable phones and other portable electronic devices.

An alternate marketing method contemplates selling the portable storage/secure connection device through a designated mass distribution outlet such as an advertising and/or promotional marketing specialty house. The sale would still be in mass quantities for end users, but would be more similar to a retail sale approach. A user would still receive the portable storage/secure connection device and would also enjoy preferred shopping as a member of the basic Passport System site upon registration and authentication.

The portable storage/secure connection device and Passport System also permits a novel marketing tool. Having sponsors allows the portable storage/secure connection device to be given to end users freely, allowing sponsors to make associations with other trusted parties. In this manner, the portable storage/secure connection device may be specifically geared to engender trust between the sponsor and the user, since transactions authorized and authenticated via the portable storage/secure connection device allow private and secure communication between the user, sponsor or other trusted merchants. By using the portable storage/secure connection, a user is able to trust the sponsor and the sponsor's ability to secure and protect personal information online and offline. Additionally, since trust is established between the user and the sponsor, the sponsor may introduce other trusted merchants to the user for up-selling or cross-selling opportunities. In this manner, a chain of value is created for all stakeholders via the portable storage/secure connection device and Passport System. This marketing tool is also intended to function in a mass distribution context via promotional giveaways by large corporate sponsors. Third party merchants might also pay for the privilege of fulfilling referred market requests. In addition, the manufacturer of the device could bill the sponsor for subletting advertising space.

### BRIEF DESCRIPTION OF THE FIGURES

FIG. 1 is a block diagram of the present invention, wherein the portable storage/secure connection device of the present invention is connected to a computer.

FIG. 2 depicts an embodiment of the portable storage/secure connection device of the present invention.

FIG. 3 depicts the user interface and web browsing screen of the Passport System portal of the present invention.

FIG. 4 depicts one embodiment of the back-end implementation of the Passport System interface portal of the present invention.

FIG. 5 depicts the toolbar of the present invention.

FIG. 6 shows a radio frequency identification (RFID) circuit chip fixed to the portable storage/secure connection device of the present invention.

FIG. 7 depicts a scenario in which RFID chip fixed on a portable storage/secure connection device is communicating with a transceiver installed in a location.

FIG. 8 shows a diagram of a portable storage/secure connection device according to one alternative embodiment, including a networked configuration of computers adapted for engaging a portable storage/secure connection device according to the present method.

### DESCRIPTION

The method and apparatus described herein is a portable storage/secure connection device containing software which redirects cached data generated during Internet browsing, such as history, cookies, favorites, emails, and passwords, among others. It causes information that would normally be recorded onto the hard drive of a host computer to be redirected onto the memory of the portable storage/secure connection device. In addition, it incorporates a secure, private web-based communication application, designated a Passport System interface to incorporate a personalized marketing capability into the portable storage/secure connection device. The method and apparatus comprises a novel marketing tool relying on the portable storage/secure connection device, the Passport System, and the Personalized and private use interface to build trusted relationships between sponsors and users of the portable storage/secure connection device.

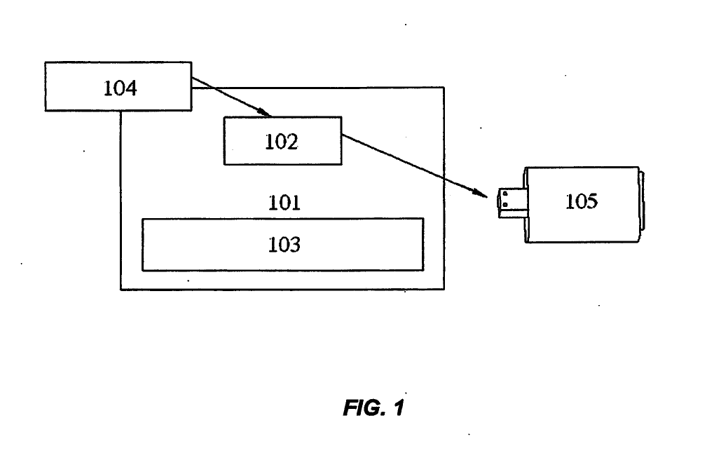

FIG. 1 is a block diagram showing storage of browser data in an arrangement with the portable storage/secure connection device connected to a computer. The diagram displays a computer 101, having a registry 102, a primary hard drive 103, an Internet browsing application 104, and the portable storage/secure connection device 105. The registry 102 is a part of the operating system settings [not shown]. An Internet browser 104 operates in connection with the operating system.

The portable storage/secure connection device 105 consists of a memory portion, housing, a connector and a cover. The memory portion may accommodate a broad range of portable storage/secure connection device capabilities and is connected to an internal processor. The housing may be designed in a variety of ways, in one preferred embodiment as a shock-resistant key fob or other small device, and the connector may be any connection mechanism with which a computer connects to peripheral devices, including radio frequency or infrared light.

As a user performs the initial setup of a typical Internet browser 104, a selection can be made that indicates where to store temporary Internet files. This setting is maintained in the registry 102. Normally, when typical default settings are selected, temporary Internet files are saved to the primary hard drive 103. However, when the portable storage/secure connection device 105 is connected to the computer 101, it queries the registry 102 settings in the operating system for the current location of temporary files. It then changes the registry 102 settings, instructing the Internet browser 104 to save temporary files on the portable storage/secure connection device 105.

As a user browses the Internet, the operating system makes no distinction between a user's hard drive 103 and the portable storage/secure connection device 105. After the portable storage/secure connection device 105 is connected, and the registry 102 changed, the computer 101 stores temporary files (history, cookies, passwords etc.) exclusively onto the portable storage/secure connection device 105. When a user finishes browsing, the portable storage/secure connection 105 is properly disconnected from the computer 101. The computer 101 then reverts back to its normal mode of operation, with no trace of personal information collected during the browsing session stored on the hard drive 103. The information from portable storage/secure connection device 105 governed Internet sessions is maintained on the portable storage/secure connection device 105.

Each portable storage/secure connection device has elements of a unique device identifier (UDI) consisting of a random pass code (hash code) that resides within the portable storage/secure connection device software and in the Passport System authentication database. The Passport System is responsible for creating the UDI utilizing elements of information contained on the portable storage/secure connection device. The generated UDI is then sent back to the portable storage/secure connection device and stored on the device for future use. When a user enters a password and registers a portable storage/secure connection device, the UDI is sent to the Passport System authentication database, creating a relationship between the individual portable storage/secure connection device and the sponsor in that database. The Passport System then checks for updates from the sponsor and/or distributor and prompts the user if updates are available. The portable storage/secure connection device then displays a toolbar, complete with an image specified by the sponsor, completing the initial registration process.

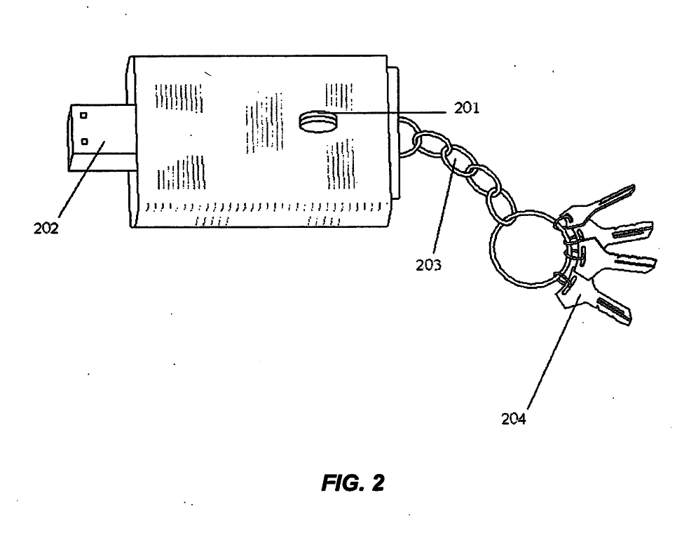

FIG. 2 shows one embodiment of the portable storage/secure connection device 105 linked with ordinary door keys 204. The portable storage/secure connection device comprises a processor and memory portion 201 and a computer connector 202. An optional key chain 203 and keys 204 are also shown. The memory 201 stores temporary files downloaded from the Internet while browsing. The computer connector 202 facilitates the attachment of portable storage/secure connection device to any computer. In the preferred embodiment of FIG. 2, the connector is preferably universal serial bus (USB) port compatible. To highlight the portable storage/secure connection device's portability, it is shown secured with keys 204 attached to the key chain 205.

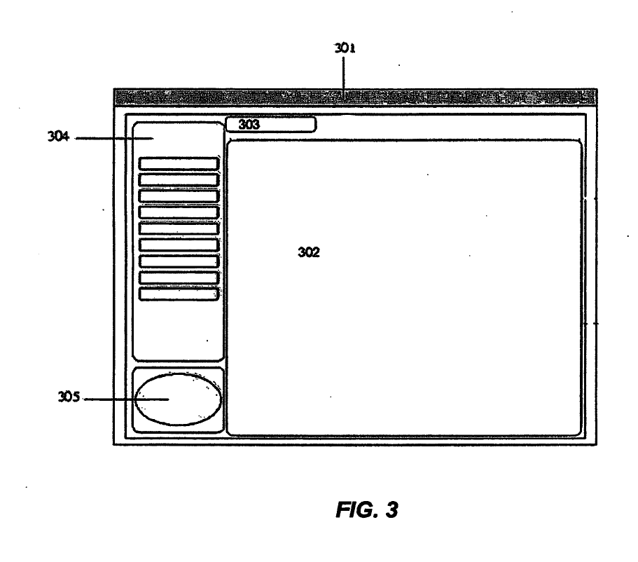

Referring to FIG. 3, the screen of the Passport System interface of the present invention is shown, which is accessed through two-factor authentication. The Passport System interface is typically a window consisting of an outer frame 301, and an inner window designated a sponsor panel 302. The outer frame 301 and sponsor panel 302 may appear as one integrated page. The outer frame 301 is generic for all users, and is divided into sections. Each section contains a different suite of utility web applications, operating from within the frame 301. The various sections comprise a secured messaging and protected browsing panel 303, services panel 304 and a rewards panel 305. The sponsor panel 302 is displayed independently, adjacent to the other sections.

The sponsor panel 302 is exclusively reserved for marketing and advertising initiatives by sponsors of the Passport System. The sponsor panel 302 is designed to accommodate Internet applications offered by third parties for marketing purposes. In one preferred embodiment of the present invention, applications provided by user-approved third parties operate as marketing tools and engage users with interactive advertisements such as rich media content, streaming video, etc.

After a user registers and activates the portable storage/secure connection device, the portable storage/secure connection device toolbar is displayed each time the portable storage/secure connection device is connected to the computer. When a user clicks on the sponsor's logo or sponsor defined link, the portable storage/secure connection devices ends its specific UDI to the Passport System server. The Passport System server authenticates the device and opens the personalized and private user interface to the sponsor.

The sponsor panel 302 is activated and receives targeted messages through the personalized and private user interface. In one preferred embodiment of the present invention, sponsors may derive behavior data through the portable storage/secure connection device once it connects to the Passport System interface. The portable storage/secure connection device may also be designed to pull data for select services depending on a user's registration information, and the sponsor panel 302 can operate in real-time, reacting to a user's changing demographic profile in order to tailor and serve marketing or advertising campaigns to that user.

A secure messaging and private browsing panel 303 comprises a secure and instant messaging application, which allows users to maintain the privacy of their online conversations with sponsors, merchants, etc. The private browsing panel 303 opens another browser window utilizing a proxy to create a secure SSL connection between host computer and the Passport System interface located on the proxy server. This type of connection enhances the privacy features of the portable storage/secure connection device beyond the local computer and out onto the Internet. The content being directed to and from the user's host computer is encrypted and passed from the browser window through the proxy server. The system relies on SSL protocols to encrypt and transmit data packets, making the UDI data elements, URL, and information transmitted from the sponsor's server/website through the Passport System proxy server to the user's host computer virtually unintelligible. Even a local administrator won't have access or visibility to the specific sites visited. The only information that appears in the local host's log file is the proxy's internet address. This effectively provides anonymity on the web outside of the sponsor site.

The service panel 304 comprises a merchant center, allowing either a sponsor or a trusted merchant to cross-sell or cross-market products or services that are geared toward the user, and which compliment the sponsor's offerings.

The rewards panel 305 comprises reward programs presented by the Passport System sponsor that provide various offers and personal rewards, such as coupons or points to participating users. These reward programs are presented by the sponsor through the Passport System interface, and the Passport System interface is capable of displaying any pages provided by the sponsor, with the exception of pages employing a “no frames” command. These programs are targeted to specific end users.

A secure chat section [not shown] comprises a secure instant messaging application, which allows users to maintain online conversations in private through the Passport System interface.

In a preferred embodiment of the present invention, an HTML frame is used for integrating the outer frame with the inner window of the Passport System interface portal. Further, the utility web applications are preferably coded using software comprising JavaScript, JSP, ASP, VBScript, C+, or a combination. The remaining code for configuring the Passport System interface portal may be written in software comprising XML, DHTML, HTML, or a combination thereof. Development for the back end is based on software comprising ASP.NET, SQL Server, JSP technology or others. The front end software comprises HTML, DHTML, JavaScript/Flash, VBScript, XML and XSLT.

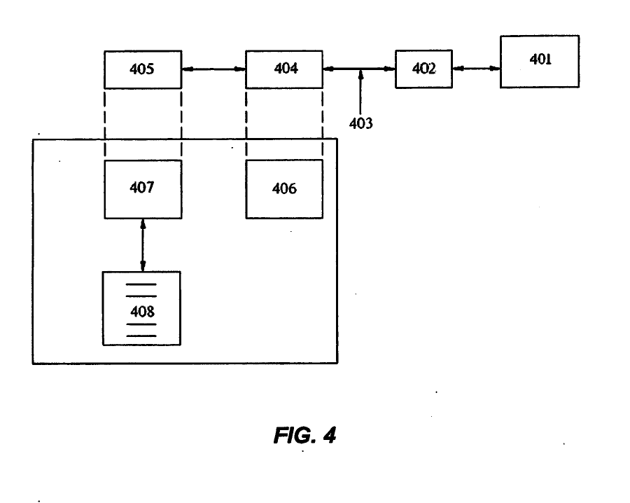

Referring to FIG. 4, one embodiment of the back-end implementation of the Passport System interface portal is shown. It comprises of user portable storage/secure connection device 401, user's host computer 402, Internet link 403, proxy server 404, sponsor server 405, back end server 406, back end sponsor Server 407, and mainframe 408. The user's portable storage/secure connection device 401 is connected to the user computer 402 while browsing using the Internet link 403. The front-end software for the Passport System interface portal outer frame runs on the server 404. The front-end software for the Passport System interface portal inner window runs on the server 405.

For smaller clients, the back end software for the Passport System interface portal sponsor panel may run on the server 404. The back end software (active server pages) for customizing the Passport System interface portal runs on the back end server 406. The back end software for connecting sponsor forms to the mainframe 408 runs on the back end sponsor server 407. Back end data encryption occurs at the mainframe, back end sponsor server and back end server. The backend system (mainframe, CRM, ERP or data warehouse) 408 is used to store confidential user data and is typically contracted by the sponsor. Any communication from the back end to a mainframe, etc., will not be encrypted as it is assumed that the request has already been authenticated.

The Passport System Server 404 monitors the active dialog between the end user, sponsored web pages and the sponsor's data server. This maintains the privacy of the Portable storage and secure connection device user and still provides sponsors with enough information to know what has captured the interest and focus of the end user.

The sponsor's data server maintains a history of the user's interactions on the sponsor's site through the use of a web service on the hosting server, code integrated with the web content hosted by the Passport System and associated proxy servers and the UDI of the Portable storage and secure connection device. Content in the Passport System interface site is created with the idea of creating a drill down approach to discerning the interests of the user. In conjunction with a particular marketing campaign, the sponsor can aggressively mine the user activities seeing how a user has interacted with the content presented to the user as defined within the limitations of the user's privacy profile.

Content delivered to the user's sponsor panel is administered by via web based admin utility which allows the scheduling and delivery of content, the creation of links for the service menu via web service applications, the uploading of new images for the toolbar, and the downloading of reporting data for analysis by the sponsor for marketing purposes.

Active server pages on the two back-end servers can be written with Java, C, C++, ASP.net or other languages. Regardless of the active server pages' code language, the software remains compatible as is generally known in the art, making this integration possible.

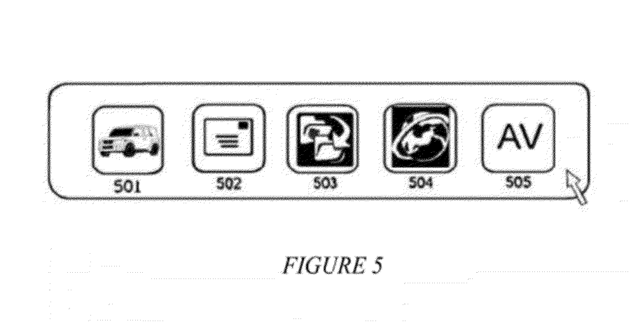

Referring to FIG. 5, a preferred toolbar of the present invention is shown. The toolbar comprises icons representing utility applications which assist in maintaining the privacy of a mobile portable storage/secure connection device user. The software enabling the toolbar is stored on the portable storage/secure connection device. The software is operating system compatible and runs on the host computer to which the portable storage/secure connection device is connected. The icons on the toolbar comprise a login icon 501, an email access icon 502, a file synchronizer icon 503, an Internet access icon 504, and a special utility icon 505.

Clicking the email access icon 502 launches a personalized and private use interface, or allows a user to select from a variety of applications. Depending on portable storage/secure connection device user preferences and application availability, the user selects one of these programs. When an email program launches, portable storage/secure connection device firmware and software redirects the path for data storage to a portable storage/secure connection device location. Data storage default pathways are restore to original host settings when the portable storage/secure connection device is properly ejected. Also, the user's personal Internet account settings, including mail server, email address, account name, password, incoming mail server (POP3), outgoing mail server (SMTP) which are stored on the portable storage/secure connection device and are imported and take effect when the email program is launched. Emails stored on the portable storage/secure connection device can be read, and new emails can be sent and received using the email program without leaving a trace on the hard drive of the computer after the portable storage/secure connection device is disconnected.

Clicking on the file synchronizer icon 503 launches a profile window for data exchange between the portable storage/secure connection device and the computer. The profile window enables users to copy data based on parameters such as file size, file type, or date modified, and also helps determine the storage location of files and folders. This function provides the unique ability to know which files are new and which files need to be updated.

Clicking on the Internet access icon 504 launches a secure browser, configured by the abovementioned procedure to cache temporary files downloaded from the Internet onto a portable storage/secure connection device location.

Clicking on the special utility icon 505 consisting of plug-ins or links allows third party applications such as anti-virus protection, anti-spam and/or a firewall to be executed. An alternate usage of the special utility icon features convenience packed applications that may automate tasks such as automatic form filling, security, and privacy setting applications.

In an alternate embodiment of the invention, where a particular portable storage/secure connection device and Passport System interface is sponsored, a sponsor may host the Passport System interface and have control over password selection. In this instance, the sponsor password and portable storage/secure connection device will be used to authenticate the user.

Upon login, through the registration process, the portable storage/secure connection device identifies itself with a sponsor and links to the Passport System homepage through a secure SSL connection. By employing two-factor authentication, the Passport System verifies that the user fits the prescribed market segment for the portable storage/secure connection device sponsor. Through ASP.net, or similar technology, the Passport System matches and tailors sponsor pages to the prescribed market segment. The market segment match benefits both the user and the sponsor, and the two-factor authentication process prevents fraud and ID theft.

In another embodiment, the toolbar software application is designed for storage on a portable storage and secure connection device of at least 64 MB memory and USB 2.0 compliant. The application has an initial footprint on the portable storage/secure connection device of less than 12 MB, allowing users space for personal files.

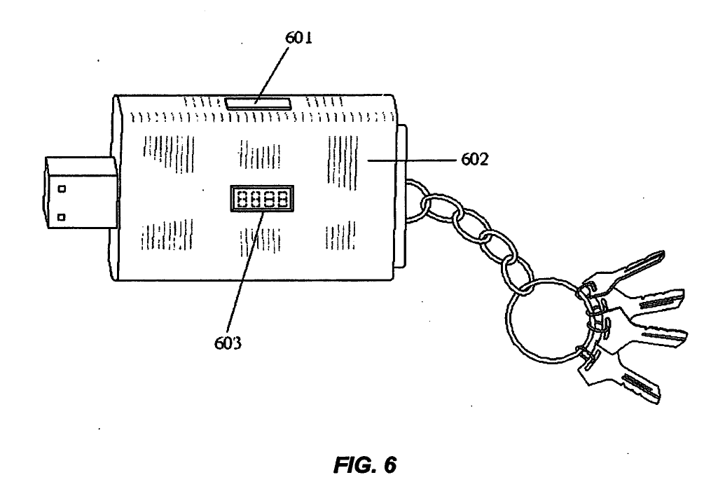

FIG. 6 shows the portable storage/secure connection device of the present invention incorporating a radio frequency identification (RFID) circuit chip. It comprises an RFID chip 601, the portable storage/secure connection device 602, and a display panel 603. The RFID chip 601 is a transponder powered by radio frequencies transmitted by a transceiver. Such transmissions become effective within a short distance (e.g. 100 m) between the transponder 601 and the transceiver. In one embodiment, the portable storage/secure connection device 602 employs a rechargeable battery powered active transponder to send a large amount of data over long distances. In another embodiment, a passive transponder may be used for economy models of the portable storage/secure connection device 602 to transmit small amounts of data, such as the portable storage/secure connection device identifying information.

In a preferred embodiment, the display panel 603 consists of an LCD display without a rear light. A super capacitor charges and operates the display panel 603. A location charges the display panel 603 with RF from the location transceiver. The portable storage/secure connection device 602 rectifies the RF and applies it to the super capacitor.

In one embodiment, transceivers are typically operated by businesses sponsoring the portable storage/secure connection device. The portable storage/secure connection device 602 stores data including member user identification information. The display panel 603 is preferably an LCD display panel on which store marketing benefits and offers are displayed in the form of text messages.

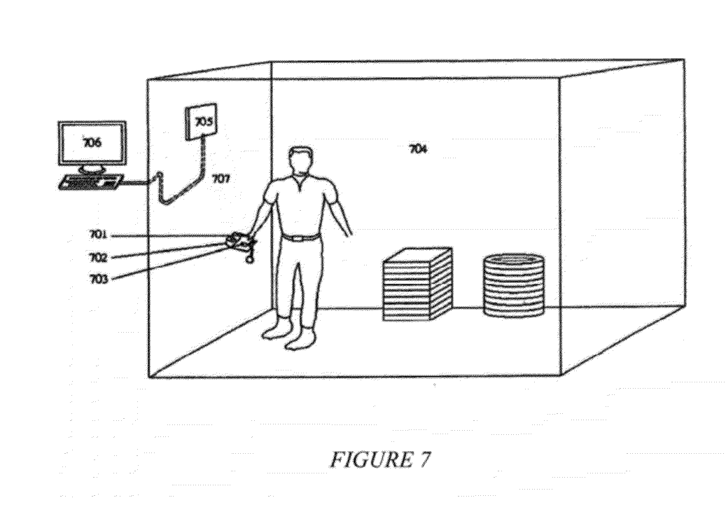

FIG. 7 shows one embodiment in which an RFID chip fixed on a portable storage/secure connection device is communicating with a transceiver installed in an independent or chain retail outlet. It comprises the RFID chip 701, portable storage/secure connection device 702, display panel 703, customer center 704, transceiver 705, portable storage/secure connection device sponsor back end system 706, and radio frequency waves 707.

When a portable storage/secure connection device and user enter the independent or chain retail outlet 704, radio frequency waves 707 transmitted by the independent or chain retail outlet transceiver 705 power the RFID chip 701 and identify a portable storage/secure connection device member. An audible signal or “beep” from the RFID chip 701 may indicate an authenticated member. Full authentication requires both the portable storage/secure connection device and user password. Authentication constitutes the user's permission to register. With the user permission, processes running on the independent or chain retail outlet servers and/or mainframe can then automatically register the user. In that case, after authentication, the RFID chip 701 acquires user identification data from the portable storage/secure connection device memory and transmits it to the independent or chain retail outlet transceiver. The server matches the portable storage/secure connection device 702 information with complete records in its back-end data server 706. At this point, e-registration takes place, and access to member benefit/privileges is activated.

The independent or chain retail outlet system may confirm e-registration with a message on the display panel 703. The message area may also display the consumers ID. If the independent or chain retail outlet participates in member benefits, the display will indicate these. Such benefits will target to the consumer's needs and might include: visibility to preferred brand products, comparable products, related products, or new member services/benefits, etc.

Other markets that could use the combined portable storage/secure connection device and Passport System include lending libraries, video stores, health clubs, or virtually any retail outlet.

Permission Based Platform

In another alternative embodiment, the portable storage/secure connection device and Passport System comprises a method for providing users with a permission-based, secured platform for accessing, uploading and downloading educational information or PII to or from sponsored and unsponsored Internet sites, to the user, other sponsors or approved third parties. That method is characterized by the following steps: removably connecting a portable storage/secure connection device and a host computer; activating firmware in the portable storage/secure connection device, the firmware causing the host computer to recognize the portable storage/secure connection device as peripheral hardware, launching proprietary software contained on the portable storage/secure connection device to assume control of the host's operating system browser registry key; re-directing data traditionally managed by the Internet browser key registry onto the portable storage/secure connection device or onto a Passport System server instead of the host computer; transmitting information from the portable storage/secure connection device using custom applications and algorithms capable of decrypting, authenticating, and encrypting the transmitted information; directing said information to a web server via a proxy server, the web server accessing programs from an application server for decrypting transmitted information, authenticating the portable storage/secure connection device and the user through personally identifying information, and providing a data server to store captured and encrypted data, and facilitate the authorized transfer of user-approved PII stored within a Passport System server, transfer between the sponsor and the user, transferred between sponsors, or transferred between sponsors and authorized third parties; and upon completion of the user's interaction with sponsored or non-sponsored site, returning control of the browser registry key process to the host computer's operating system upon removal of the portable storage/secure connection device.

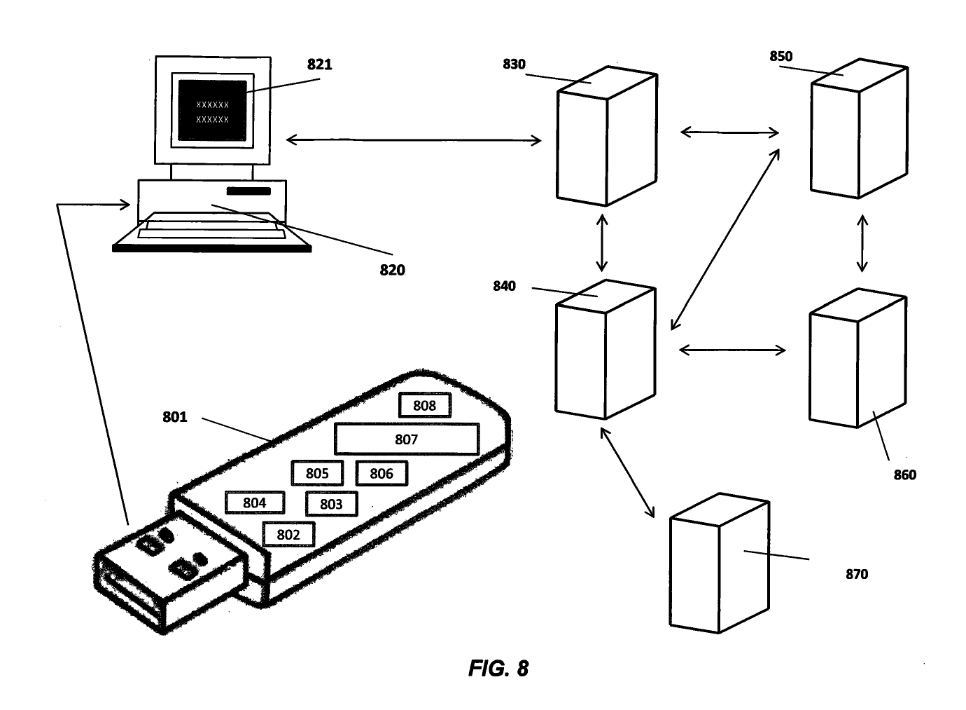

In this embodiment the Passport System FIG. 8 describes the infrastructure that supports the claims within this document. The Passport System includes the portable storage/secure connection device, proxy server(s), web server(s), application server(s), and data server(s).

As defined earlier, upon insertion of the portable storage/secure connection device into the host computer tracking devices (cookies, etc.) are redirected to an alternate storage location (e.g., the device or a Passport System server) removing one method of user tracking/identification. The next method of tracking involves capturing the host computer's IP address. This method of user/host computer tracking is nullified by the utilization of a proxy server 803. In this embodiment the URL of a target proxy server 803 is embedded into a portable storage/secure connection device. Once the host computer connects to the proxy server it is immediately redirected to the campaign server as defined by profile settings within the proxy server. This redirection shields the identity the IP address of the user's host computer which in effect shields the identity of the user.

The web server 840 provides a user interface for entering and capturing all click stream activity including creating login credentials, entering PII and connecting the user to the sponsor or non-sponsored server(s).

The application server 850 manages device and user authentication as well as all sponsor related activities and communications.

The data server 860 houses all encrypted program/campaign, sponsor, and user related information. This server plays a key role in the data decryption and encryption, device validation, user login, storage of PII, storage of advertising or communication messages, backend reporting, and other sponsor-related information.

The method may also include the steps of; providing a USB interface between the portable storage/secure connection device and the host computer, the host computer identifying the portable storage/secure connection device specifically as a keyboard, connecting the portable storage/secure connection device to the host computer and through firmware, to cause the host computer to recognize the portable storage/secure connection device as peripheral hardware. A target proxy URL and other data and program elements are incorporated into the portable storage/secure connection device for transmission to and through the Passport System servers via a secure protocol.

The USB device should comply with Universal Serial Bus (USB) standards and classifications set forth by USB Implementers Forum. Each standard or classification allows the device to (be designed to) act as a host, a peripheral device, or combination of the two. By definition, a smart phone using a USB ON-THE-GO can act as both a host and a device at different times, whereas a drive is considered a peripheral device and a personal computer is considered a host.

The Passport System can initiate or access tasks or processes as a USB mass storage device (MSD), or USB key, or as USB composite device using standards such as USB HID (Human Interface “Device”), USB OTG (ON-THE-GO), or USB wireless from any personal computer or terminal running common operating system software. The only requirement is that the device is capable of executing custom firmware, and responding to software commands sent from a host.

As USB specifications allow, different embodiments of the device shown in FIG. 1 may or may not contain more than one single USB interface. (A USB interface is essentially a separate form of functionality that the device can manifest. Each USB interface can act independently of other USB interfaces in the device, so that the multiple interfaces in a USB composite device may behave as if they were independent devices that happen to share the same USB cable.)

One type of USB interface that might be found in the device would conform to USB Mass Storage Device (MSD) class standards and is exemplified by the many USB “Thumb Drive” devices that are commonly available. Another type of USB interface that would likely be in the device would be a special type of USB MSD Human Interface Device Class Interface (HID) that represents itself as a keyboard. In the case of the contemplated device, this HID “keyboard” that when combined with custom firmware is capable of launching custom programs within the device or Passport System by sending command strings to the computer host, one character at a time, just as if they were being typed into a standard USB keyboard by an individual. A third type of USB limited storage device would likely be another USB HID Class Interface that would be used to program the character strings into the device that the phantom keyboard interface would send to the computer host when the device is plugged in.

USB Key with Limited Memory

Still referring to FIG. 8, one embodiment of the system contains a USB key with limited memory for data (on the order of 1 MB or less), and contains only USB interfaces of type 2 and 3 above, to represent itself to the computer host as a phantom keyboard that can be customized through the type 3 interface. This embodiment specifically does NOT represent itself as a USB mass storage device or drive. This embodiment has enough capability to execute firmware and software commands.

Mass Storage Device Interface

Another embodiment contains a USB Mass Storage Device (MSD) interface described as type 1 above, in addition to the type 2 USB interface discussed above. This embodiment would utilize the HID phantom keyboard functionality. The portable storage/secure connection device may, upon user approval be used to house cookies or other tracking devices, click stream history, and PII or privacy profile elements captured from sponsors/third parties or through user data entry. The device may also contain programs and files not likely to be present on the user's computer when the device is plugged into the user's computer host for the first time.

It is contemplated that using any of the three types of USB interfaces users may be prompted, upon connection of the USB device may trigger the Passport System to install with the user's permission, programs (e.g., extensions, plugins, app's or widgets) and files for user convenience, on their host computer, or it may simply cause applicable programs to be run directly from the USB drive aspect of the device. The user has the ability to accept or decline installation of a desktop shortcut icon, extensions, plugins, widgets or request the ability to download an app to their smart phone or tablet providing access to the secure Passport System without the USB device. Upon acceptance, a shortcut, plugin, extension or widget is created and placed on the host computer. If an app is requested the user is sent instructions via email to download the app onto the target device. A history record of any or all convenience pathways selected for download to the Host computer, tablet or smart phone is written to a Passport System data server.

Internet browsing (click stream history) is controlled and managed by the operating system's browser registry key function storing the user's click stream history in hidden files. Browsers keep these records and do not delete them when a user empties the browser cache. The Index.dat folder is the location of the aforementioned hidden files. These files contain URL trails and cookies that users believe they have deleted. There are three types of index.dat files: Temporary Internet .dat files store HTML code and pictures opened during a browsing session. Manual, user initiated file cleaning techniques does completely eliminate all elements of these tracking tools—instead, their action may remove the files but records of the file are still maintained on the system. Cookies .dat files contain cookies left from site visits. Clearing cookies removes most but not all of these files. History .dat files contain all URLs the user has ever accessed (intentionally and unintentionally)

Writing information to these files is an automated browser process which cannot be overridden by the user. In order to remove this type of user tracking and personal identification through custom software, the device assumes control of this process and redirects where information is stored during the browsing session, then disposes of the information accordingly.

Once the device is connected to the host computer, assumes control of host computer registry keys, redirects storage location of Internet tracking devices (cookies, etc., as previously discussed), and connects the user to the web server, the user is presented with an authentication interface, which may initially present as a user greeting. For example a “Greetings/Stand by for Authentication” web page, signaling commencement of the authentication process.

Still referring to FIG. 8, the authentication process involves the steps of the device 801 releasing a predetermined proxy URL 803 via the phantom keyboard 802 through the host computer 820, connecting the host computer to the proxy server 830. The proxy server 830 provides a redirect link to a web server 840. The web server 840 communicates with the application server to begin the device authentication process. The application server 850 triggers the device 801 to release an alpha/numeric string 804 for validation by the Passport System (FIG. 8).

If the proxy server indicates the alpha/numeric string 804 is valid, the application server 850 triggers an application 807 on the device 801 to open a first lockbox 805 containing an encrypted code. A separate application 807 on the device 801 decrypts the encrypted code in the first lockbox 805, which, when decrypted, causes the application 807 on the device 801 to open a second lockbox 806. Once the second lockbox 806 is open, the application 807 on the device 801 triggers an algorithm in the second lockbox 806 to validate the now-decrypted code from the first lockbox 805. Upon validation, the application 807 on the device 801 communicates a “key valid” message to the application server 850.

With validation completed, a user may proceed to the registration process. The first registration step is automatic: the application server 850 captures host computer 820 internal component serial numbers, which are encrypted and saved to the data server 860. The application server 850, via the web server 840 then requests personal authentication information from the user (user password, security question response, user consent/data access authorization, alternate contact info, etc.), and alternate contact methods (an email address or phone number to receive a text message). That information is also encrypted by the application server 850 then written to the data server 860.

Next, the application server 850, via the web server 840 asks the user to accept or reject placing optional navigation tools (such as desktop short cuts, browser plug-ins, etc.) on the host computer 820. If approved, the application server 850 takes the additional step of installing the approved items. Whether or not optional navigation tools are accepted, after that decision has been made by the user, the application server 850 then creates a unique device identifier (UDI) 808 and personal URL (PURL), encrypts the UDI 808 and PURL and writes them to the device 801 and data server 860. The application server 850 then initiates a device and user registration process using the user interface 821 displayed on the host 820 which is released from the web server 840. The user/device registration information is then encrypted and written to the data server 860. It is anticipated the application server 850 will display a customized PURL replacing the user interface 821, with content-specific links, messages, etc. A user may use those links to connect to the Sponsor Portal.

The device utilizes Secure Socket Layer Security (SSL) and Transport Layer Security (TLS) protocols to provide a secure and private pathway to sponsored and unsponsored web-based information. SSL/TLS are cryptographic protocols that provide communication security over the Internet and are recognized as the industry standard for secure, encrypted transmission of data packets. SSL/TLS protocols encrypt the segments of network connections above the Transport Layer, using symmetric cryptography for privacy and a keyed message authentication code for message reliability. TLS is an IETF standards track protocol, last updated in RFC 5246 and is based on the earlier SSL specifications developed by Netscape Corporation. TLS is also a standard method to protect Session Initiation Protocol (SIP) application signaling. TLS can be used to provide authentication and encryption of the SIP signaling associated with VoIP and other SIP-based applications. It is anticipated that as security protocols continue to evolve, next generation internet security encryption and secure data transmission protocols and standards will be integrated into the invention.

Finally, as content captured and stored on the Passport System data server will continue to evolve over time, automated and repeatable back-end server-based monitoring and reporting software as well as third-party security audits will serve as a system guard continuously searching and flagging potential security/exposure risk opportunities thereby facilitating the ability to preempt exposure and close gaps while continuously ensuring the infrastructure as well as content captured and maintained via Passport System functionality remains private and secure.

It is anticipated in one embodiment, therefore, that the steps of applying SSL/TLS secure transmission protocols, two-factor authentication protocols, and encryption methodologies for protecting privacy profile data transmitted through a proxy server to and from the sponsors server or portal will be included. Also Passport System servers may capture, decrypt, create, encrypt and store each unique device identifier (UDI) by combining data pre-programmed information stored on and transmitted from the portable storage/secure connection device with a Personal URL (PURL) and other elements generated by applications resident on a Passport System application and data servers.

The web browser accessed through the Passport System proxy may server provide the user with links to a web page created by the sponsor or provider of the portable storage/secure connection device. It is anticipated that the sponsor's server or portal may require an Application Program Interface (API) hand shake to facilitate interaction between servers/systems. The API serves as an authentication and decryption key to facilitate bi-directional data flow between the sponsor's web page/portal, Passport System servers, the host computer and the device. It is also anticipated that the web page/portal will provide at least one separately coded outer frame having a utility web application, and a separately coded inner frame for accepting user input, accepting user request for files/information, and displaying predetermined information.

Users may be prompted to accept or decline a browser plug-in to access the sponsor site through the Passport System in the future. If accepted, a plug-in is posted to an open browser, and the MSD writes to the Passport System data server that the browser plug-in option was selected. In instances where users choose to the system by smart phone or tablet-based browsers, the Passport System will advise the user that upon confirmation an email will be sent to them that must be opened on the target device (smart phone or tablet). This email contains a link to initiate the app download process which when opened within the smart phone or table, the user may be prompted to accept or decline installation of an app on the device used. As is the case with both browser plug-ins and desktop shortcut icons, upon acceptance, the Passport System data server is informed that this option was selected.

The system also provides a Desktop layer facilitates device and user authentication; providing a Sponsor layer for allowing the user to register for the program or campaign allowing the sponsor to communicate with the user to request, for example, approval to capture click stream history while on their site or portal, define PII they have available, or PII information they wish to capture; providing a Non-Sponsored layer that serves to redirect click stream history information to a secure database on the proxy server and allow future access of the click stream history by the user or user's advocate, providing a Customization layer allowing a user to personalize their view and access frequently used objects, providing an Engagement layer which delivers the sponsor's product or service information to a user, providing a Consent/Access layer to allow the user to define their consent and access authorization (governing the information to be released, the parties to whom the information is released, and governing the specific criteria for releasing the information) parameters, and a Rewards layer for allowing sponsors to incent users for demonstrating desired actions as defined by the sponsor.

USB Keyboard Emulation

It is anticipated that after connection to the host computer, the device and its executable computer program (firmware inside a microcontroller in the device), presents itself as a USB HID keyboard, thereby sending (in a timed sequence) a predefined sequence of alpha/numerical characters (key codes, pass codes, scripts, serial numbers etc.), which when received and validated by the Passport System triggers a series of events which authenticate the device, establish user login credentials, then combine the authenticated alpha/numeric string with a Personal URL (PURL) generated by a server-based application to create a Unique Device Identifier (UDI). The UDI is then written to both the device and the applicable Passport System data server for future access.

Utilizing this standardized keyboard emulation technique, the USB HID automatically (without manual intervention) sends the UDI contained on the portable secure connection device as computer keystrokes, via a secure SSL/TLS pathway, through the host to the Proxy server which then redirects the string to the applicable URL within the Passport System for code decryption, device authentication and access to the personalized and private web interface. This standardized keyboard emulation technique prevents the operating system from blocking operation, as frequently happens in the prior art when those systems try to directly execute “autorun” batch scripts from conventional USB MSDs.

During the initial key authentication and registration process, whether by USB or USB emulation, and regardless of connection method, the host computer's serial numbers are captured and written to a Passport System data server. Upon disconnect, and reconnect, if those serial numbers do not match (for instance, if the connection is made from a different host computer) an alternate contact method protocol is triggered. In such an instance, the user is presented with an Alternate Contact Method Interface and asked to designate which alternate method of communication the Passport System should utilize to deliver temporary access credentials. If designated, a temporary authorization code is generated and sent by the selected method to the user, who can upon receipt, enter the code for verification. It is anticipated any temporary authorization codes will expire relatively quickly, in one embodiment upon the expiration of ten (10) minutes if not used.

Passport System Interface

Referring to FIG. 9, the Passport System Interface is separate but integrated with current Web browsers or downloadable plug-ins in its integration (using string commands) with the device. In conjunction with a web browser it can function as a common interface utilizing a variety of web-orientated standards and protocols (i.e. JAVA, CGI, .Net etc.) to communicate and interact between web servers and web applications or frameworks.

This integration (between embedded features of the device, the proxy server which shields the identity of the user's host computer IP address and by association the user's identity, the utilization of a web browser to deliver a personalized user interface, Passport System server based applications for decryption of information embedded on the device, device authentication, and user authentication, Passport System servers to house sponsor program/campaign rules and requirements, Passport System server based applications to provide to the user a personalized platform to define and capture PII or PII consent and access rules, Passport System server based applications for data encryption and storage of private user profiles, the housing of click stream history, and back end reporting as defined within user authorized parameters) creates a web-centric experience that using SSL/TLS protocols is secure/private for the bi-directional transmission of encrypted information, allowing or denying access from or to information available from the sponsor or third party gateway and content servers. When looking at a user interface, the screen contains one or a combination of objects (e.g., web page, landing page, micro-site, portalets, or web application), which house information, content, or clusters of material (images, diagrams, etc.)

Interface Screens

In one contemplated embodiment, the interface screen is framed by seven distinct layers that make the browsing experience easy to navigate, intuitive, and secure/private whether browsing is initiated from a sponsored or non-sponsored motivation.

The Desktop layer facilitates the device authentication and user login process. Additionally, this layer includes the latest technology for integration with new or existing browsers with or without an operating system (OS), (i.e. IE, Firefox, Chrome, Chrome-OS, Opera, etc.). The Desktop layer also allows the user to utilize the Passport System to act as a consent/access/use clearing house providing the user with the ability to identify and define PII stored by the sponsor or third parties which can be electronically shared between the sponsor and third parties based on specific criteria and decision sets as established by the user on an ongoing basis. In one embodiment PII is not stored on the device or within the Passport System. Instead, only user-defined criteria and decision sets defining what PII can be transmitted between defined sponsors and third parties is stored on a Passport System data server.

The Sponsor layer serves as a platform, in one embodiment, as a platform user registration to participate in the sponsor's program or campaign in order to supply PII to the limit they deem appropriate with sponsors. The user has the ability to selectively determine, on an ongoing basis, which information, whether maintained on the device, on their host computer, within a Passport System data server, or identified third party server, they will share with sponsor(s) and which information they choose to protect based on their personal decision sets. Information stored on the device and Passport System data server(s) are encrypted providing a level of protection in the event the system is illegally accessed by an outside party. This interface may allows users to access links provided by a single sponsor or to request via the Passport System the addition of other third,party links that share similar business attributes deemed important to the user, allowing the user to consolidate access to the original sponsors, additional sponsors and third party participants via one device.

The Sponsor layer is customized to the sponsor's requirements and serves as a platform to request or receive information from the user, or obtain authorization request or distribute information from the sponsor to an authorized third party via the Passport System. Within this layer's interface sponsors define relevant information requirements which will allow, if authorized by the user, a more personalized experience while also, facilitating permission to capture user-approved browsing activities (click stream behaviors). In this embodiment the user maintains control of all permissions for the sponsor to access, use, or track PII or browsing activities stored in a Passport System data server. These functions are activated through the device when connected to the Passport System. The device may also be designed to access authorized data for select services depending on a user's registration information. This layer has the ability to record with the users permission their changing profile parameters including consent/access preferences allowing the sponsor to deliver authorized information to or receive information from the user; allowing the pre-defined third parties to deliver authorized information to or receive information from the user; or allowing transmission of authorized information (bi-directionally or uni-directionally) between the sponsor and user's pre-defined third parties. Regardless of the level of PII sharing between the user, sponsor or authorized third party, or click stream activity tracking permitted by the user, this layer provides a platform to track and independently measure the effectiveness of the sponsor's communication distribution channel (e.g., the path and constituents/media needed to get the device into the user's hands, from a marketer to sales staff, from marketing/sales to a distributor, from the distributor to an advocate/trusted source, and finally from the trusted source to the end user), in order to evaluate the effectiveness of the sponsor's communication distribution methodologies and channel providing greating visibility to activities that impact ROI metrics.

The Non-Sponsored layer allows users to navigate through the Internet in a secure and private environment. All cookies and click stream history are redirected to the USB MSD or a designated Passport System data server. The user or user's guardian/advocate can access this history file to monitor/manage internet use and browsing activities.

The Customization layer (optional) facilitates creation and user access to personal URLs (PURLs), desktop shortcuts, browser plug-ins and smart phone apps and provides users with access to frequently used objects (standalone or combinations) gathered from either the designated program/campaign server, online sources or directly from the user's host computer.

The Engagement layer (optional) provides users a set of recommended references and links to encourage engagement with the sponsored material/information.

The Consent/Access/Audit layer facilitates user consent/authorization to allow access and/or release information provided by the User and captured in a Privacy System data server to sponsors or other user-authorized third parties within request specific pre-defined parameters. In this embodiment, the system is continuously monitoring the Consent/Access/Audit layer and evaluating a user's request to expand the list sponsors or third parties the user would like to access with a single device via the Passport System.

The Consent/Access/Audit layer is also the foundation of the clearing house which facilitates the user's ability to define and authorize the extent of PII that can be transmitted between the sponsors and third parties for the purpose of allowing the receiving party to capture the users PII from multiple sources allowing the sponsor to be in a position to make informed decisions and recommendations for the benefit of the user. In this layer the user not only defines what PII can be released but also can control on a case-by-case basis where the PII can be released to with a corresponding audit trail of all activity.

The Consent/Access/Audit layer provides users, approved sponsors, and authorized third parties the ability to request audit reports, at a macro level, related to the consent, access, and electronic transmission of PII between parties. Audit trail information will not include PII details and may be limited to date of user authorization, requesting party, date of request, receiving party, date of request, and types of information transmitted (for example, the report would identify that GENDER was approved to be released but would not include the users gender).

The Rewards layer (optional) allows sponsors to utilize game theory tactics to recognize and rewards users for demonstrating specific and desired actions, (e.g., rewards/compensates user for authorizing access to PII or click stream history, responding to inquiries, requesting additional information, making a purchase, reconnecting frequently to site to obtain new information, etc.)

In this embodiment, the layered interface approach provides users with a web centric private and secure pathway to an integrated and organized source of up-to-date information and content, which can be viewed online and either printed or stored directly on the user's host computer or separate storage device.

Although the present invention has been described in considerable detail with reference to certain preferred versions thereof, other versions are possible. For example, the present invention can be utilized in other contexts such as military installations or in-house corporate departments without departing from the spirit or intent of the invention. Therefore, the spirit and scope of the appended claims should not be limited to the description of the preferred versions contained herein.

What is claimed is:

1. A method for providing users with a permission-based secure Internet browsing for sponsored and unsponsored content comprising:
(a) connecting a host computer and a removable portable storage/secure connection device;
(b) activating firmware in the removable portable storage/secure connection device causing the host computer to recognize the removable portable storage/secure connection device as peripheral hardware, the firmware assuming control of the host computer's Internet browser registry key application to re-direct Internet click stream history activity and user keystrokes onto the removable portable storage/secure connection device or data server for encryption and storage for future access on a designated back-end data server;
(c) transmitting a URL to a proxy server which then redirects the user to a predetermined web server destination;
(d) transmitting an encrypted alpha-numeric string of information from the removable portable storage/secure connection device to the predetermined web server destination, then using protocols to de-crypt the encrypted alpha-numeric string for authentication;
(d) transmitting a program to open a first lockbox to obtain an encrypted code;
(e) upon successfully opening the first lockbox, triggering an application on the device to open a second lockbox; containing a decryption key, which decrypts the code revealed in lockbox I;
(g) the second lockbox running a validation algorithm against the decryption key;
(h) an application capturing the serial numbers of selected components of the host computer;
(i) registering the decryption activity and capturing user registration information via the web server;
(j) allowing the user to define and enter PII and encrypting and securing the PII in a data server;
(k) allowing the user to request access to multiple sponsor or third party web-based information/resources via one device;
(l) allowing the user to define access and consent rules for access to information stored on the data server including information sent between a third party and a sponsor;
(m) providing an audit trail that details PII transmission of data between parties;
(n) providing access to one or more sponsors to communicate biographical user information; and;
(o) returning control of the Internet browser key application to the host computer upon removal of the portable storage/secure connection device.

2. The method of claim 1 including the step of providing a USB interface between the portable storage/secure connection device and the host computer.

3. The method of claim 1 including the step of the host computer identifying the portable storage/secure connection device as a keyboard.

4. The method of claim 1 including the step of connecting the portable storage/secure connection device to the host computer, and firmware transmitting information causing the host computer to recognize the portable storage/secure connection device as peripheral hardware.

5. The method of claim 1 including the step of incorporating a target URL into the portable storage/secure connection device.

6. The method of claim 1 including the step of applying two-factor authentication protocols, and prevailing secure data transmission protocols to transmitted information.

7. The method of claim 1 including the step of utilizing a network of secure servers, (proxy server, web server, application server and data server) to capture, decrypt, create and encrypt a unique device identifier for the portable storage/secure connection device from device based and server based information in order to shield the IP address of the user's host computer.

8. A method for providing users with a permission-based secure Internet browsing platform for sponsored and unsponsored content comprising:
(a) connecting a host computer and a removable portable storage/secure connection device;
(b) activating firmware in the removable portable storage/secure connection device;
(c) software located on a system application server triggering firmware on the removable portable storage/secure connection device causing the host computer to register the removable portable storage/secure connection device as peripheral hardware, and assuming control of the host computer's Internet browser registry key function to re-direct Internet click stream history data onto the removable portable storage/secure connection device or a Passport System data server instead of the host computer;
(c) transmitting information from the removable portable storage/secure connection device using protocols capable of authenticating and encrypting the transmitted information; and
(d) directing said information through a proxy server to an application server, the application server requiring authentication of the removable portable storage/secure connection device and the user, and having a database and software to encrypt, decrypt, store, redirect, authenticate, and connect to a sponsor gateway, facilitate transfers of user-authorized information;
(e) the software causing the host computer to open a web browser to a predetermined uniform resource locator; and
(f) returning control of the Internet browser registry key function to the host computer upon removal of the removable portable storage/secure connection device.

9. The method of claim 8 including the step of the web browser directing the user to a web page sponsored by the provider of the removable portable storage/secure connection device.

10. The method of claim 9 including the step of the web page requiring authentication and encrypting data flowing between the web page and the host computer.

11. The method of claim 9 including the step of the web page providing at least one separately coded outer frame having a utility web application, and a separately coded inner frame for accepting user input and displaying predetermined information.

12. The method of claim 9 including a step chosen from the steps of; providing a desktop layer enabling the user to selectively supply and authorize access to PII to the sponsor, providing a sponsor layer for capturing user-generated and user-authorized click stream history and PII, providing a non-sponsored layer that only redirects click stream information, providing a customization layer allowing a user to access frequently used objects, providing an engagement layer providing information suggesting services to a user, and a rewards layer for allowing sponsors to reward users based on click stream activity.

13. A method for providing users with a permission-based secure Internet browsing for sponsored and unsponsored content comprising:
(a) connecting a host computer and a removable portable storage/secure connection device;
(b) activating firmware in the removable portable storage/secure connection device, the firmware causing the host computer to register the removable portable storage/secure connection device as peripheral hardware, while assuming control of Internet browser registry key functions of the host computer to re-direct Internet click stream data onto the removable portable storage/secure connection device or a proxy server instead of the host computer;
(c) transmitting information from the removable portable storage/secure connection device using industry-recognized secure data transmission protocols capable of encrypting the transmitted information sent to the Passport System for authentication; and
(d) directing said information through a proxy server, to an application server facilitating the second level of authentication of the portable storage/secure connection device and the user, and having a database and software to capture, encrypt, decrypt, store, redirect, authenticate, and facilitate transfers of user-authorized PII;
(e) the software causing the host computer to open a web browser to a webpage provided by a health care sponsor or array of health care sponsors;
(f) returning control of Internet browser registry key function to the host computer upon removal of the removable portable storage/secure connection device.

14. The method of claim 13, including the step of continuously monitoring the second layer and monitoring a user's PII.

15. The method of claim 13, including the step of utilizing information defined by the user in the consent layer as a clearing house for the direct distribution of PII between the sponsor and third parties.

16. The method of claim 13, including the step of accessing electronic information transmitted between the user and the sponsor.

17. The method of claim 13, including the step of providing user information approved personal healthcare information to user-approved third party health care providers.

18. The method of claim 13, including the step of downloading, printing, or otherwise generating a copy of a user's information.

19. The method of claim 13 including the step of distributing large numbers of removable portable storage/secure connection devices to users based on mass market databases.

20. The method of claim 13 wherein the removable portable storage/secure connection device is packaged individually or in multiple units per package.
